(19) United States
(12) Patent Application Publication
(10) Pub. No.: US 2013/0217399 A1
(43) Pub. Date: Aug. 22, 2013

(54) PARTIAL CHANNEL MAPPING FOR FAST CONNECTION SETUP IN LOW ENERGY WIRELESS NETWORKS

(71) Applicant: TEXAS INSTRUMENTS INCORPORATED, (US)

(72) Inventors: Ariton E. XHAFA, Plano, TX (US); Soon-Hyeok CHOI, Allen, TX (US); Srinath HOSUR, Santa Clara, CA (US); Yanjun SUN, San Diego, CA (US)

(73) Assignee: TEXAS INSTRUMENTS INCORPORATED, Dallas, TX (US)

(21) Appl. No.: 13/766,335

(22) Filed: Feb. 13, 2013

Related U.S. Application Data
(60) Provisional application No. 61/600,925, filed on Feb. 20, 2012.

(51) Int. Cl. H04W 72/04

(52) U.S. Cl. CPC H04W 72/04
USPC 455/450

(57) ABSTRACT

A system comprising a controller, a scanner, and a transceiver. The controller is configured to identify a number of channels in which a beacon signal may be wirelessly transmitted. The number of channels is less than a total number of channels available for receiving transmissions. The scanner is configured to scan each of the number of channels for a first beacon signal. The transceiver is configured to receive the first beacon signal from one of the number of channels.

### CROSS-REFERENCE TO RELATED APPLICATION

The present application claims priority to U.S. Provisional Patent Application No. 61/600,925, filed on Feb. 20, 2012 (Attorney Docket No. TI-72049PS); which is hereby incorporated herein by reference in its entirety.

### BACKGROUND

Wireless Sensor Networks (WSNs) are used in various application areas, including industrial process monitoring and control, environment and habitat monitoring, traffic control, building automation, healthcare applications, etc. In some such applications a powered sensor may be used in a harsh environment, and it is desirable for the sensor to be untethered after deployment for as long as possible. However, most sensors are powered by batteries, and limited battery capacity is a major limitation for deployment of untethered sensor nodes. Finite sensor node lifetime implies finite lifetime of the applications or additional cost and complexity to replace batteries. In order for a sensor node to connect to the WSN, it must receive a specific data transmission, beacon, from a coordinator within the WSN providing the service set identification (SSID) and other connection information for the network. The coordinator transmits beacons periodically in any channel within the network. There are no dedicated channels for beacon transmission. Furthermore, the beacon channel may change from slot frame to slot frame in a random pattern. In other words, the coordinator may transmit the beacons in any channel while the channel for beacon transmission may change from slot frame to slot frame. Thus, it may take a substantial amount of time for a sensor node to connect to the network because the sensor node must scan each channel to receive the beacon. Because the sensor node must maintain an active radio while attempting this connection and due to the substantial amount of time awaiting connection, battery drainage may occur limiting the lifetime of the sensor node, and thus, the WSN.

### SUMMARY

Systems and methods for identifying beacon channel information in a Wireless Sensor Network are disclosed herein. In some embodiments, the system includes a controller, a scanner, and a transceiver. The controller is configured to identify a number of channels in which a beacon signal may be wirelessly transmitted. The number of channels is less than a total number of channels available for receiving transmissions. The scanner is configured to scan each of the number of channels for a first beacon signal. The transceiver is configured to receive the first beacon signal from one of the number of channels.

In another illustrative embodiment, a method includes identifying a plurality of channels in which a beacon signal may be transmitted, scanning each channel within the plurality of channels for a first beacon signal transmission, and receiving the first beacon signal from one of the plurality of channels. The plurality of channels has a number of channels less than a total number of channels available for receiving transmissions.

In yet another illustrative embodiment, a system includes a controller and a transceiver. The controller is configured to identify beacon channel transmission patterns. The transceiver is configured to transmit beacon channel information.

In a further illustrative embodiment, a method includes identifying beacon transmission patterns and transmitting beacon channel information. Both the identifying and transmitting are accomplished through the use of a first wireless device.

### BRIEF DESCRIPTION OF THE DRAWINGS

For a detailed description of exemplary embodiments of the invention, reference will now be made to the accompanying drawings in which:

FIG. 1 shows a block diagram of an illustrative wireless sensor network in accordance with various embodiments;

FIG. 2 shows a block diagram of a sensor node configured to access a wireless sensor network in accordance with various embodiments;

FIG. 3 shows a conceptual illustration of the technique disclosed herein, in accordance with various embodiments;

FIG. 4 shows a flow diagram for a method for partial channel mapping in a wireless sensor network in accordance with various embodiments; and

FIG. 5 shows a flow diagram for a method for transmitting and identifying beacon channel information in a wireless sensor network in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In order to maintain battery life of a sensor node within a WSN, efficiently connecting the sensor node to the network is beneficial. Because maintaining an active radio consumes a large amount of power, it is desirable to design the network to reduce connection times, thereby, reducing the time the radio need be active. Thus, power consumption is reduced. Embodiments of the present disclosure provide an efficient design for connecting sensor nodes to a WSN by reducing the time the radio of the sensor nodes need be active.

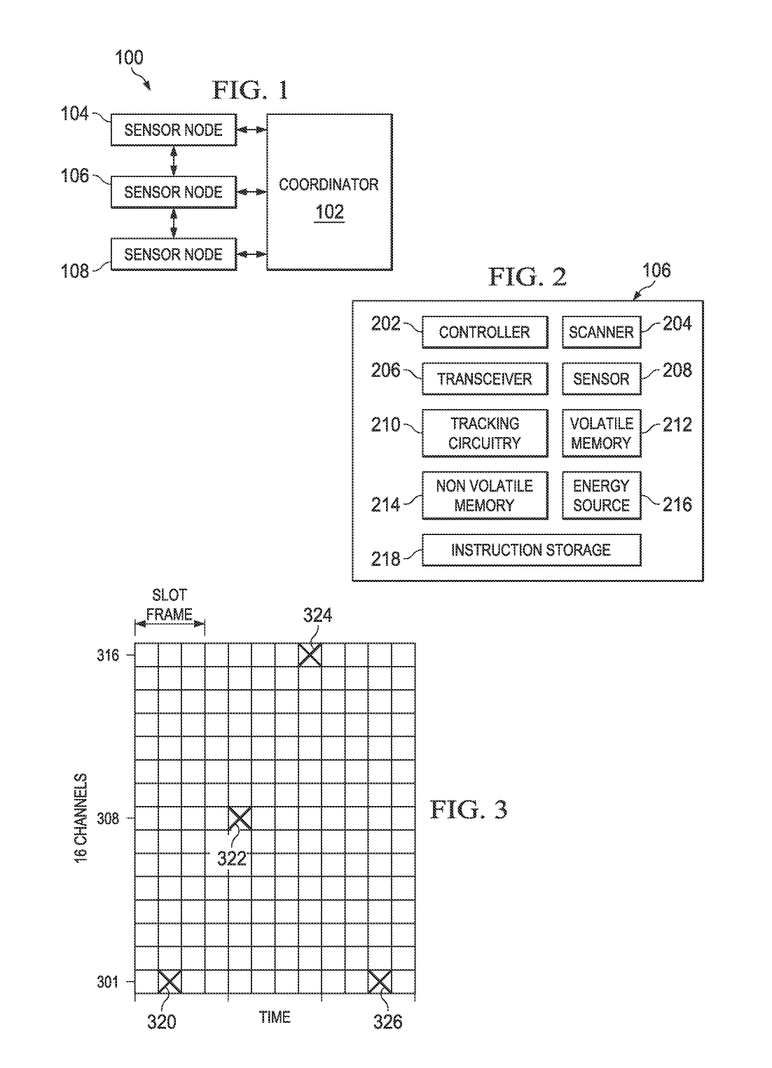

FIG. 1 shows a block diagram of an illustrative wireless sensor network (WSN) 100 in accordance with various embodiments. Network 100 includes a coordinator 102 and a plurality of wireless sensor devices (104, 106, 108), also referred to as wireless sensor nodes or simply, sensor nodes. Wireless sensor nodes 104-108 detect a condition of the environment in which they are disposed, and wirelessly communicate information indicative of the sensed environment to the coordinator 102. Each wireless sensor node may communicate with neighboring wireless sensor nodes to form an ad-hoc network in which a wireless sensor node repeats transmissions received from other sensor nodes to relay data through the network 100. Coordinator 102 may be configured to manage the sensor nodes 104-108, collect and analyze data received from sensor nodes 104-108, and connect network 100 with a wide area network (WAN) for remote data access. Coordinator 102 receives measurement values and other information transmitted by the sensor nodes 104-108, and may provide control information to the sensor nodes 104-108. While, as a matter of convenience, FIG. 1 shows only three sensor nodes 104-108 and a single coordinator 102, in practice, the network 100 may include any number of sensor nodes and coordinators. Network 100 may reduce the time in which sensor nodes 104-108 need to monitor for a beacon signal by limiting the channels in which a beacon signal may be transmitted or by sensor nodes 104-108 transmitting beacon channel information to each other.

FIG. 2 shows a block diagram of a sensor node 106 configured to access a wireless sensor network 100 in accordance with various embodiments. Sensor node 106 includes a controller 202, a scanner 204, a wireless transceiver 206, one or more sensor(s) 208, volatile memory 212, non-volatile memory 214, an energy source 216, and instruction storage 218. Some embodiments also include tracking circuitry 210. The controller 202 may be a general-purpose microprocessor or other instruction execution device suitable for use in a wireless sensor node. The volatile memory 212 may be a semiconductor random access memory (RAM), such as static RAM (SRAM), or other volatile memory suitable for use in the wireless sensor node 104. The non-volatile memory 214 may be a FLASH memory, electrically erasable programmable read-only memory (EEPROM), ferroelectric RAM (FRAM), or other non-volatile memory suitable for use in the wireless sensor node 104. Instruction storage 218 may comprise non-volatile and/or volatile memory for storing software instructions that are executed by the controller 202.

The sensor(s) 208 include one or more transducers that detect conditions about the wireless sensor node 106 and provide measurements of the conditions to the controller 202. For example, embodiments of the sensor(s) 208 may measure temperature, pressure, electrical current, humidity, or any other parameter associated with the environment of the wireless sensor 106. The transceiver 206 converts signals between electrical and electromagnetic forms to allow the wireless sensor node 106 to communicate with the sensor nodes 104 and 108, the coordinator 102, and other devices. Scanner 204 scans available frequency channels for transmissions from the sensor nodes 104 and 108 and/or coordinator 102. The energy source 216 provides power to operate the controller 202, the memories, 212, 214, and other components of the wireless sensor node 106. The energy source 216 may include a battery, an energy harvesting system, and/or other power source suitable for use in the wireless sensor node 106.

To connect to network 100, sensor node 106 must first receive a beacon from the coordinator 102 providing the service set identification (SSID) and other connection information for the network 100. In some embodiments, the network 100 operates in accordance with IEEE 802.15.4e in a sub-gigahertz or 2.4 GHz ISM band. There may be 16 channels for use within the 2.4 GHz band, each with 2 MHz of bandwidth and 5 MHz of channel separation available for coordinator 102 and sensor nodes 104-108 to transmit and receive data. In some embodiments, other frequencies and/or with a different number of channels, so long as the frequencies and channels are suitable for use in the network 100, may be used by the coordinator 102 and sensor nodes 104-108 to transmit and receive data.

In some embodiments, beacon transmission from coordinator 102 is limited to a number of channels less than the total number of channels available for transmission. For example, in the 2.4 GHz band utilizing 16 channels for transmission, only 15 or less channels may be utilized for beacon transmission. In some embodiments, the number of available channels for beacon transmission is only 3. For example, channels 1, 8, and 16 may be designated as channels available for beacon transmission. The beacons then may be transmitted by coordinator 102 in one of the channels designated for beacon transmissions. In some embodiments, the channels for beacon transmission are programmed into coordinator 102 prior to entry into the network 100 and are thus, preset.

A certain amount of time after the coordinator 102 transmits the first beacon signal, the coordinator 102 may transmit a second beacon signal in a different channel of the channels designated for beacon transmissions. Again, after a certain amount of time, the coordinator 102 may transmit a third beacon signal in a different channel of the channels designated for beacon transmissions than the first beacon signal and the second beacon signal. In some embodiments, this may continue, with the coordinator 102 transmitting beacon signals in the channels designated for beacon transmissions selecting the channel to send the beacon transmission based on a preset pattern.

Controller 202 of sensor node 106 may be configured to identify channels on which the beacon may be transmitted. In other words, when the transmission of a beacon is limited to certain channels less than the total number of channels available for receiving transmissions, controller 202 is configured to identify which of the channels the beacon may be transmitted. The number of channels and the specific channels in which a beacon may be transmitted may be programmed directly into the sensor node 106 during network 100 set up. Hence, in some embodiments, scanner 204 only scans each of the channels designated for beacon transmission and does not scan all of the available channels. Transceiver 206 is configured to receive beacon transmissions from coordinator 102.

By limiting the number of channels scanner 204 needs to scan for beacon transmissions, there is a higher likelihood that scanner 204 finds a beacon signal in a reduced amount of time. Scanning time, the time it takes for scanner 204 to find a beacon signal, sometimes referred to as listening time, may be identified by the following equation:

Node Listening≧n*x

where n is the number of channels available for beacon transmission and x is the beacon time interval. In some embodiments, the beacon time interval is 10 seconds or less. Thus, with the reduction of channels selected to transmit the beacon, the time for node listening will be reduced.

In some embodiments, the number of channels selected by coordinator 102 for beacon transmission is not reduced from the total number of channels available for transmissions. For example, if 16 channels are available for transmissions, all 16 channels are available for beacon transmission as well. Controller 202 of sensor node 106 may be configured to identify beacon channel transmission patterns. This may be accomplished utilizing scanner 204 to scan all of the channels for a beacon. Once the beacon is identified, transceiver 206 receives the beacon. Controller 202 then may identify which channel the beacon was received and the time offset for beacon transmissions. Controller 202 then may identify the pattern of channels in which future beacons will be transmitted by coordinator 102.

Sensor node 106 may then transmit beacon channel information to sensor nodes 104 and 108 within packet communications which may include other information exclusive of beacon channel information. Beacon channel information may comprise from which channel the beacon was received, the time offset for beacon transmissions, and/or the pattern of channels in which future beacons will be transmitted by coordinator 102. Sensor nodes 104 and 108 then may each use its own controller to determine the beacon channel transmission patterns based on the beacon channel information transmitted by sensor node 106. This enables the sensor nodes within the network 100 to switch to the particular channel at a particular time to listen for beacons, thereby enabling sensor nodes 104 and 108 to quickly receive the beacon and join the network 100. In some embodiments, not all packets would be required to carry the beacon channel information; however, this information may be sent in every packet. If the beacon channel information is not sent in every packet, a subset of frame slots may be selected to transmit this information.

FIG. 3 shows a conceptual illustration of beacon transmissions, in accordance with various embodiments. In some embodiments, only channels 1, 8, and 16 (301, 308, and 316) are available for beacon transmissions. Thus, beacons may only be transmitted in these three channels and not in any of the other channels available for transmissions. In some embodiments, 16 total channels are available for transmissions. As illustrated in FIG. 3, beacon 320 may be transmitted in the first slot frame in channel 1 (301). Beacon 322 then may be transmitted in the second slot frame in channel 8 (308). Beacon 324 then may be transmitted in the third slot frame in channel 16 (316). Beacon 326 then may be transmitted in the fourth slot frame in channel 1 (301). As shown, the beacons may be transmitted in a preset pattern, first in channel 1 (301), next in channel 8 (308), followed by channel 16 (316) with the pattern repeating. Thus, sensor nodes 104-108 need only look in the channels selected to quickly find beacon transmissions.

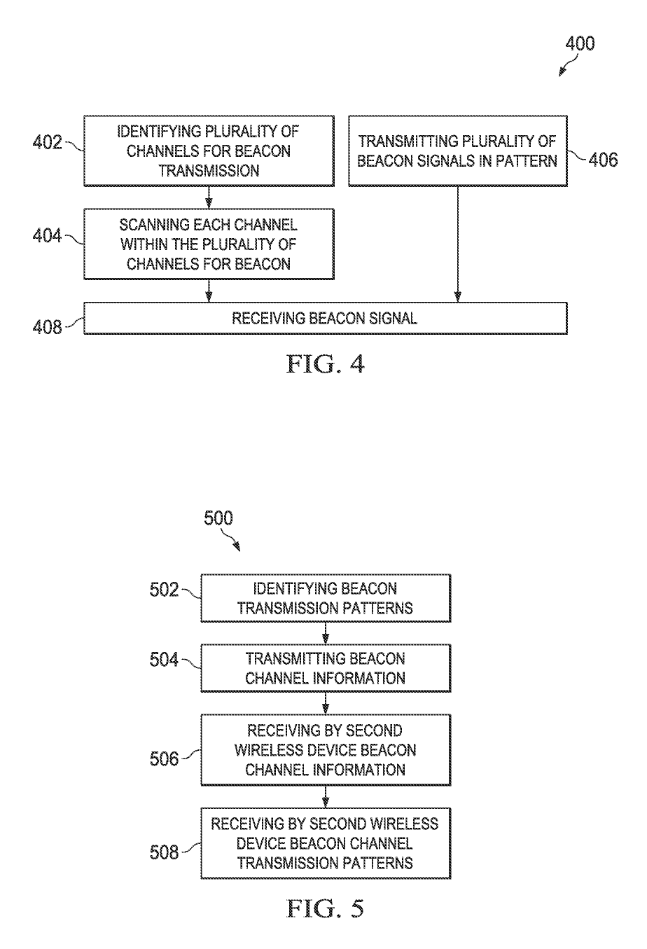

FIG. 4 shows a flow diagram of a method 400 implemented in accordance with various embodiments. The method 400 begins in block 402 with identifying a plurality of channels in which a beacon signal may be transmitted. In some embodiments, the plurality of channels has a number of channels less than a total number of channels available for receiving transmissions. The plurality of channels may be channels 1, 8, and 16, and the total number of channels for receiving transmissions may be 16 although any number of channels may be utilized so long as the number of channels making up the plurality of channels is less than the total number of channels for receiving transmissions. Furthermore, the plurality of channels may be preset. Controller 202 within sensor node 106 may identify the plurality of channels.

In block 404, method 400 continues with scanning each channel within the plurality of channels for a first beacon signal. Scanner 204 of sensor node 106 may conduct the scanning.

The method 400 continues in block 406 with transmitting a plurality of beacon signals, one at a time, each in separate channels within the plurality of channels based on a preset pattern. Coordinator 102 may transmit the plurality of beacon signals.

The method 400 then includes receiving the first beacon signal from one of the plurality of channels, as shown in block 408. The transceiver 206 of sensor node 106 may receive the beacon signal.

FIG. 5 shows a flow diagram of a method 500 implemented in accordance with various embodiments. The method 500 begins in block 502 with identifying beacon transmission patterns by a first wireless device. Beacon transmission patterns may comprise the pattern of channels in which future beacons will be transmitted. The first wireless device may be sensor node 106 and the identification may be accomplished by controller 202.

In block 504, the method 500 continues with transmitting, by the first wireless device, beacon channel information. Beacon channel information may include which channel the beacon was received, the time offset for beacon transmissions, and/or the pattern of channels in which future beacons will be transmitted. The transmission may be performed by transceiver 206.

The method 500 continues in block 506 with receiving, by a second wireless device, the beacon channel information. The second wireless device may be sensor nodes 104 or 108.

In block 508, the method 500 continues with identifying, by the second wireless device, beacon channel transmission patterns based on the beacon channel information. Thus, the first wireless device transmits beacon channel information to the second wireless device which identifies beacon channel transmission patterns based on the information received.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a controller configured to identify a number of channels in which a beacon signal is wirelessly transmitted, wherein the number is less than a total number of channels available for receiving transmissions;
a scanner configured to scan each of the number of channels for a first beacon signal transmission; and
a transceiver configured to receive the first beacon signal from one of the number of channels.

2. The system of claim 1, further comprising a coordinator configured to transmit the first beacon signal to the transceiver in one of the number of channels.

3. The system of claim 2, wherein the coordinator is further configured to transmit a second beacon signal, a period of time after the first beacon signal has been transmitted, in a different channel of the number of channels than the first beacon signal is transmitted.

4. The system of claim 3, wherein the coordinator is further configured to transmit a third beacon signal, a period of time after the second beacon signal has been transmitted, in a different channel of the number of channels than the first and second beacon signals.

5. The system of claim 2, wherein the coordinator is further configured to transmit a plurality of beacon signals, one at a time, in separate channels of the number of channels based on a preset pattern.

6. The system of claim 1, wherein the number of channels is preset.

7. The system of claim 1, wherein the total number of channels is sixteen and the number of channels in which the beacon signal is wirelessly transmitted is three.

8. A method, comprising:
identifying a number of channels in which a beacon signal may be wirelessly transmitted wherein the number of channels is less than a total number of channels available for receiving transmissions;
scanning each channel of the number of channels for a first beacon signal transmission; and
receiving the first beacon signal from one of the number of channels.

9. The method of claim 8, further comprising wirelessly transmitting the first beacon signal to a transceiver in one of the number of channels.

10. The method of claim 9, further comprising wirelessly transmitting a second beacon signal, a period of time after the first beacon signal has been transmitted, in a different channel of the number of channels than the first beacon signal was transmitted.

11. The method of claim 10, further comprising wirelessly transmitting a third beacon signal, a period of time after the second beacon signal has been transmitted, in a different channel of the number of channels than the first and second beacon signals.

12. The method of claim 9, further comprising wirelessly transmitting a plurality of beacon signals, one at a time, in separate channels of the number of channels based on a preset pattern.

13. The method of claim 8, wherein the number of channels is preset.

14. The method of claim 8, wherein the total number of channels is sixteen and the number of channels in which the beacon signal is wirelessly transmitted is three.

15. A system comprising,
a controller configured to identify a beacon channel transmission pattern based on the reception of a beacon from a coordinator; and
a transceiver configured to transmit beacon channel information that identifies the beacon channel transmission pattern.

16. The system of claim 15, further comprising at least one sensor node, wherein the transceiver is configured to wirelessly transmit the identified beacon channel information to the at least one sensor node.

17. The system of claim 16, wherein the at least one sensor node comprises a sensor node controller configured to identify beacon channel transmission patterns based on the beacon channel information.

18. A method comprising,
identifying, by a first wireless device, beacon channel transmission patterns based on the reception of a beacon from a coordinator; and
transmitting, by the first wireless device, beacon channel information identifying the beacon channel transmission pattern.

19. The method of claim 18, further comprising, receiving, by a second wireless device, the beacon channel information.

20. The method of claim 19, further comprising, identifying, by the second wireless device, beacon channel transmission patterns based on the beacon channel information.
